(19) United States
(12) Patent Application Publication
(10) Pub. No.: US 2008/0050980 A1
(43) Pub. Date: Feb. 28, 2008

(54) Modular Insulation Displacement Contact Block

(76) Inventors: Yakov Belopolsky, Harrisburgh, PA (US); David Gutter, Felton, PA (US); Richard Marowsky, York, PA (US)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/843,078

(22) Filed: Aug. 22, 2007

Related U.S. Application Data
(60) Provisional application No. 60/823,420, filed on Aug. 24, 2006.

(51) Int. Cl. H01R 24/00; H01R 13/46

(52) U.S. Cl. 439/676

(57) ABSTRACT

An insulation displacement contact block comprising a base and first, second, and third walls extending upward from the base. The first and second wall define a first wire insertion opening. The second and third wall define a second wire insertion opening. A first insulation displacement contact is disposed between the first and second wall, the first insulation displacement contact including a first side and a first edge, the first side being longer than the first edge. A second insulation displacement contact is disposed between the second and third wall, the second insulation displacement contact including a second side and a second edge, the second side being longer than the second edge. The first and second insulation displacement contacts are disposed so that the first edge faces, and is in the same plane as, the second edge. A plurality of insulation displacement contact blocks may be grouped together by a tie bar to form a strip.

This application claims priority to provisional application No. 60/823,420 entitled “HIGH SPEED SHIELDED INSULATION DISPLACEMENT TERMINATION BLOCK” filed Aug. 24, 2006, the entirety of which is hereby incorporated by reference.

### BACKGROUND OF THE INVENTION

The use of modular plugs and jacks for data transmission is known. Basically, in order to establish electrical communication and a data path between a first and second device, the first device may send information in the form of electrical signals out into a cable that terminates in a plug. The second device may include ajack. The plug and jack are designed so as to be easily mechanically mate-able in a male-female configuration. Once the plug and jack are mated, electrical members in the plug and connector engage and are electrically mated so that electrical information signals may travel from the first device to the second device.

The jack is sometimes mounted on a circuit board and connected to a plurality of wires. These wires are frequently soldered to corresponding terminals of the jack so as to ensure mechanical and electrical communication between the wires and jack. However, when a circuit board including a jack is in the field outside of a manufacturing facility, a solder connection is not always practical or even possible. Insulation displacement contacts and blocks were designed to deal with this field connection problem. FIG. 1 shows a strip 50 of four prior art insulation displacement contact blocks. Each block includes two insulation displacement contacts and is typically used for differential transmission communication where a pair of wires transmit equal but opposite voltages so that data transmission is accomplished by detecting the difference in voltage across the two wires. The contacts are electrically connected to a jack (not shown) such as by soldering before the block and jack leave the manufacturing facility. Block 68 includes two wire insertion areas 58, 64 for receiving wires therein. Wire insertion areas 58, 64 are disposed in plastic or another insulator and include insulation displacement contacts 60, 62. A shield 70 may be placed around the blocks. The insulation displacement contacts include sharp tines extending inwardly. When a field technician or assembler wishes to connect a wire 66 to block 68, the technician may insert wire 66 including insulation 52 and conductive portion 54 into wire insertion area 58. Thereafter, a punch tool (not shown) is used to punch down wire 66 into wire insertion area 58. This application of downward force causes the tines of insulation displacement contact 60 to pierce insulation 52 and make physical and electrical contact with conductive portion 54.

A problem with prior art insulation displacement contact blocks is that data being sent into one block may be detected by, and adversely affect communication in, an adjacent block. Each block may act as an antenna radiating its data transmission information and affecting the data transmission in adjacent blocks. One prior art approach to handle this problem is to tilt insulation displacement contacts 60, 62 (as shown) so that less of the surface areas of the contacts face to one another. However, such prior art approaches have not produced satisfactory results—especially in high speed communications.

### SUMMARY OF THE INVENTION

One embodiment of the invention is an insulation displacement contact block comprising a base and a first, second, and third wall extending upward from the base, the first and second wall defining a first wire insertion opening, the second and third wall defining a second wire insertion opening. A first insulation displacement contact is disposed between the first and second wall, the first insulation displacement contact including a first side and a first edge, the first side being longer than the first edge. A second insulation displacement contact is disposed between the second and third wall, the second insulation displacement contact including a second side and a second edge, the second side being longer than the second edge. The first and second insulation displacement contacts are disposed so that the first edge faces, and is in the same plane as, the second edge.

Another embodiment of the invention is a strip of at least a first and second separable insulation displacement contact blocks, the strip comprising a first contact block including a first base and a first, second, and third wall extending upward from the first base, the first and second wall defining a first wire insertion opening, the second and third wall defining a second wire insertion opening. The first contact block further including a first insulation displacement contact disposed between the first and second wall, the first insulation displacement contact including a first side and a first edge, the first side being longer than the first edge, and a second insulation displacement contact disposed between the second and third wall, the second insulation displacement contact including a second side and a second edge, the second side being longer than the second edge. The first and second insulation displacement contacts are disposed so that the first edge faces the second edge. The strip further comprises a second contact block including a second base and a fourth, fifth, and sixth third wall, each distinct from the first, second and third walls, the fourth, fifth and sixth walls extending upward from the second base, the fourth and fifth wall defining a third wire insertion opening, the fifth and sixth wall defining a fourth wire insertion opening. The second block further includes a third insulation displacement contact disposed between the fourth and fifth wall, the third insulation displacement contact including a third side and a third edge, the third side being longer than the third edge, and a fourth insulation displacement contact disposed between the fifth and sixth wall, the fourth insulation displacement contact including a fourth side and a fourth edge, the fourth side being longer than the fourth edge. The third and fourth insulation displacement contacts are disposed so that the third edge faces the fourth edge.

Yet another embodiment of the invention is an arrangement comprising a first and second strip of insulation displacement contact blocks, each strip including at least two insulation displacement contact blocks, each insulation displacement contact block comprising a base and a first, second, and third wall extending upward from the base, the first and second wall defining a first wire insertion opening, the second and third wall defining a second wire insertion opening. Each insulation displacement contact further including a first insulation displacement contact disposed between the first and second wall, the first insulation displacement contact including a first side and a first edge, the first side being longer than the first edge, and a second insulation displacement contact disposed between the second and third wall, the second insulation displacement contact including a second side and a second edge, the second side being longer than the second edge. The first and second insulation displacement contacts are disposed so that the first edge faces, and is in the same plane as, the second edge.

### BRIEF DESCRIPTION OF THE DRAWINGS

FIG. 1 is a top view of a strip of insulation displacement contact blocks in accordance with the prior art.

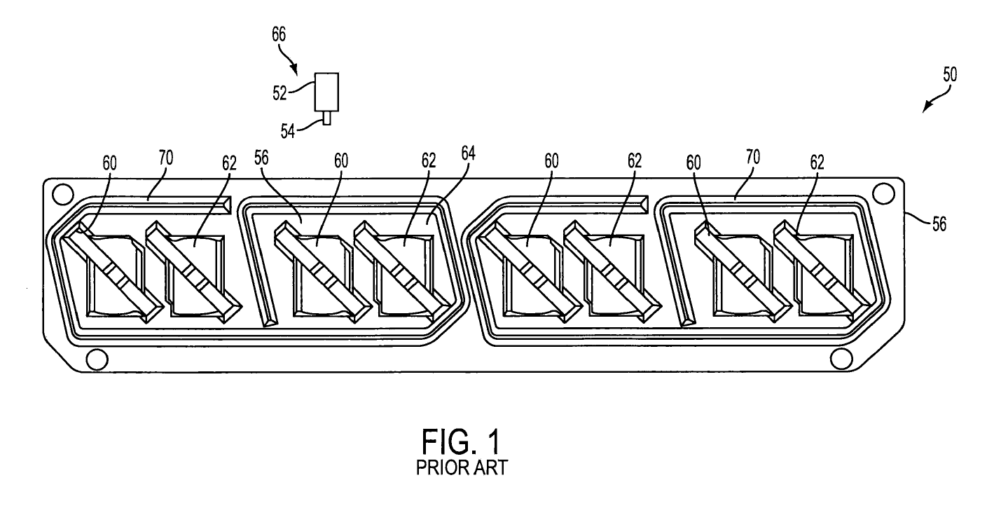

FIG. 2 is front perspective view of a strip of insulation displacement contact blocks in accordance with an embodiment of the invention.

FIG. 3 is a rear perspective view of a strip of insulation displacement contact blocks in accordance with an embodiment of the invention.

FIG. 4 is a rear view of a strip of insulation displacement contact blocks in accordance with an embodiment of the invention.

FIG. 5 is a side view of an insulation displacement contact which may be used in accordance with an embodiment of the invention.

FIG. 6 is a top view of an insulation displacement contact block in accordance with an embodiment of the invention.

FIG. 7 is a bottom perspective view of a strip of insulation displacement contact blocks in accordance with an embodiment of the invention.

FIG. 8 is a bottom perspective view of an insulation displacement contact block in accordance with an embodiment of the invention.

FIG. 9 is a top perspective view of an insulation displacement contact block in accordance with an embodiment of the invention.

FIG. 10 is a side view of a punch down tool which may be used in accordance with an embodiment of the invention.

FIG. 11 is side perspective view of a punch down tool which may be used in accordance with an embodiment of the invention.

FIG. 12 is a front perspective view of a punch down tool and strip of insulation displacement contact blocks in accordance with an embodiment of the invention.

FIG. 13 is a rear perspective view of a punch down tool and strip of insulation displacement contact blocks in accordance with an embodiment of the invention.

FIG. 14 is a top view of a strip of insulation displacement contact blocks in accordance with an embodiment of the invention.

FIG. 15 is a top perspective view a circuit board including strips of insulation displacement contact blocks and shields in accordance with an embodiment of the invention.

FIG. 16 is a rear perspective view of a cover and a strip of insulation displacement contact blocks in accordance with an embodiment of the invention.

FIG. 17 is a rear perspective view of a cover and a strip of insulation displacement contact blocks in accordance with an embodiment of the invention.

### DETAILED DESCRIPTION OF THE PREFERRED EMBODIMENT(S)

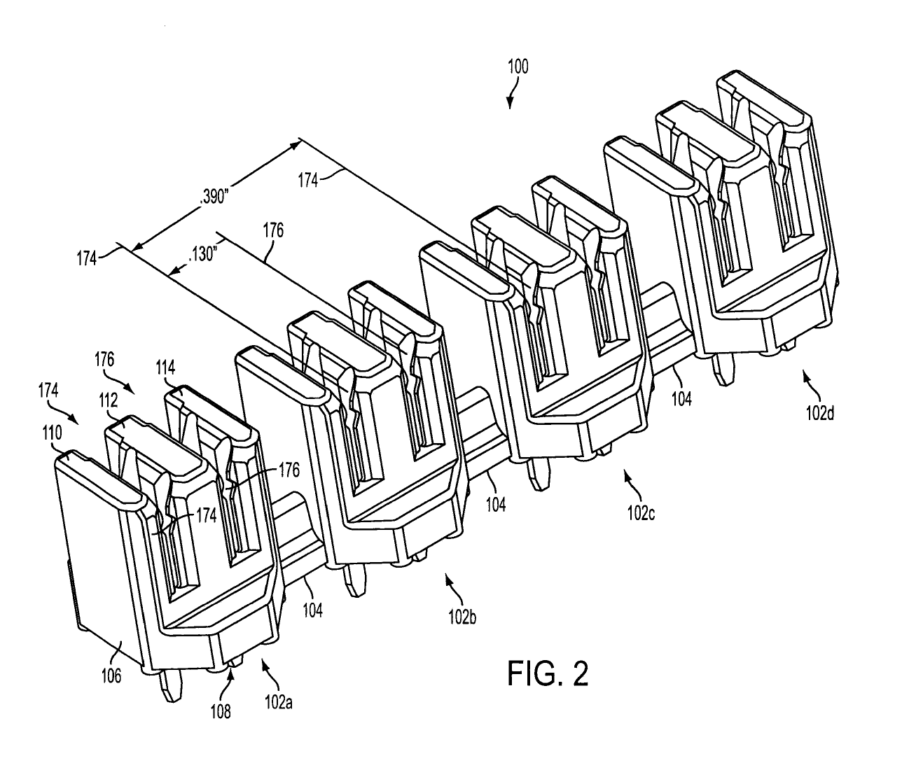

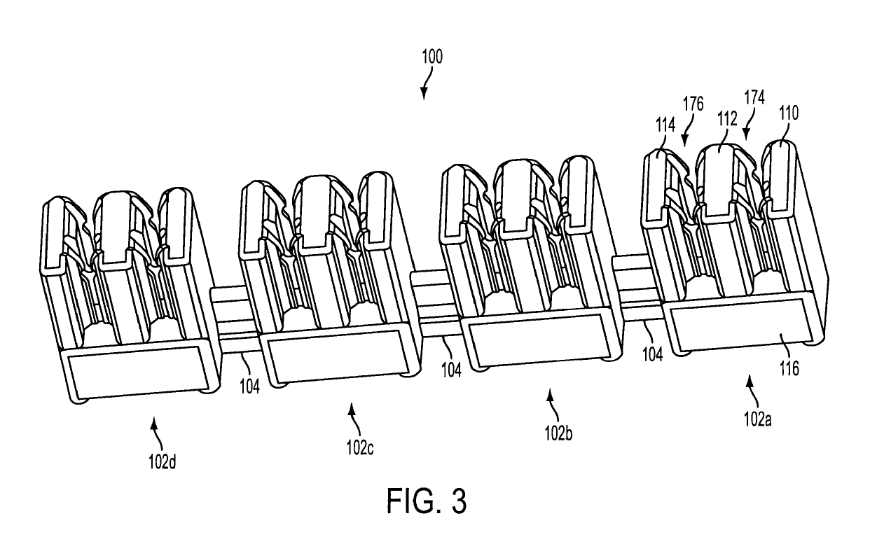

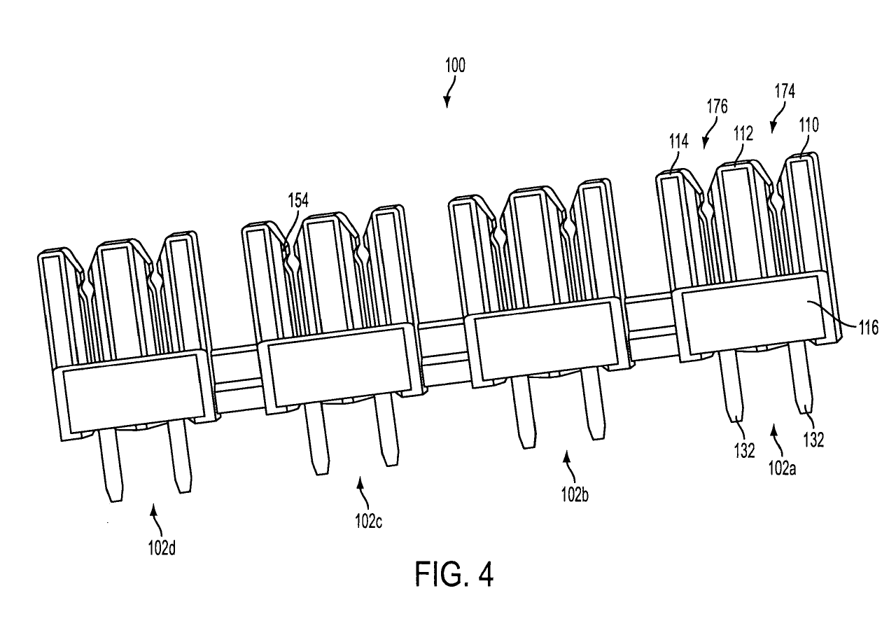

Shown in FIGS. 2-4 is a strip 100 of insulation displacement contact blocks 102 (102a, 102b, 102c, 102d) in accordance with an embodiment of the invention. Focusing on block 102a, though it should be clear that each block includes the same structural components, each block 102 includes a base 106. Base 106 has a substantially flat portion 116 on a wire insertion side (FIG. 3) of block 102 and a bent portion 108 defining three surface areas on a wire termination side (FIG. 2) of block 102. Extending upwardly from base 106 are three walls 110, 112, 114 defining a first and second wire insertion openings 174, 176 as discussed more completely below. Walls 110, 112, 114 may be made of plastic or of another insulative material.

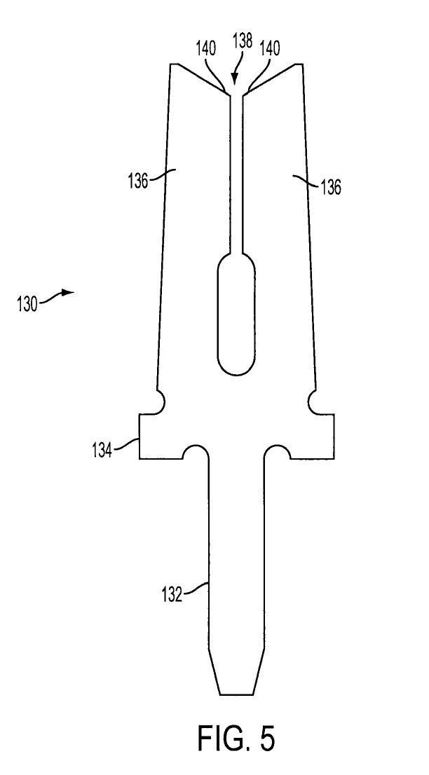

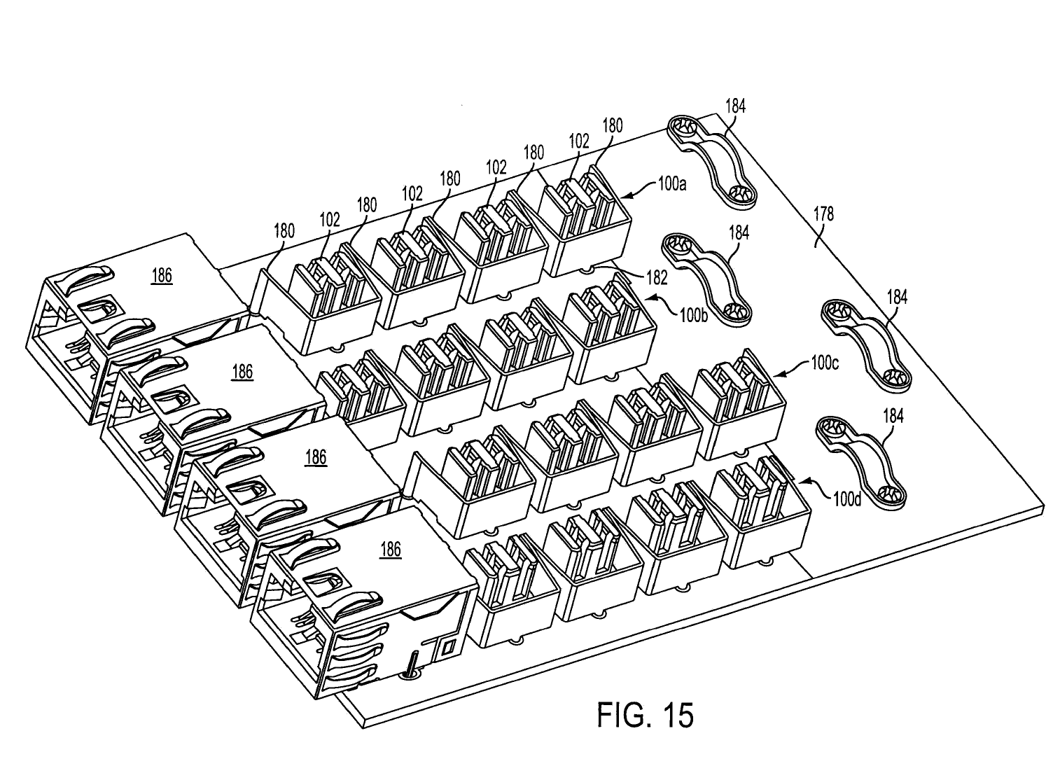

Shown in FIG. 5 is an insulation displacement contact 130 including a base portion 134 and a termination portion 132. Termination portion 132 may be inserted into a circuit board (FIG. 15) and used to mechanically and electrically mate insulation displacement contact 130 with the circuit board and possibly a jack. Extending upwardly from base 134 are tines 136. Tines 136 include sharp edges 140 that define an entrance of a wire insertion path 138.

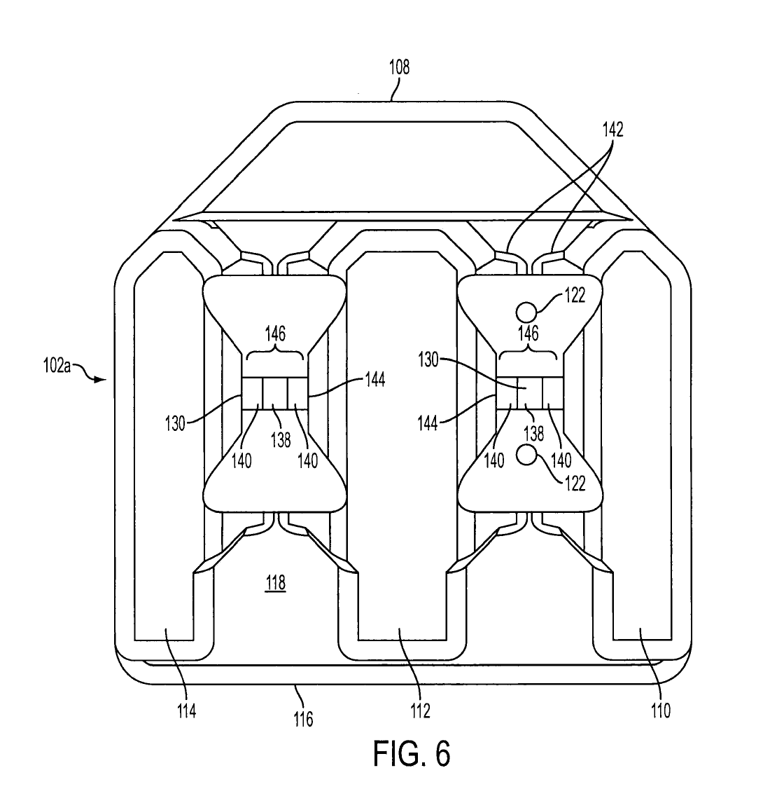

Referring to FIG. 6, walls 110, 112, 114 define punch tool clearance cavities 122 which may be used to receive a punch down tool discussed more completely below. Walls 110, 112, 114 further define a wire insertion cavity 118 which provides an area for a technician to insert a wire into block 102a. By defining a wire insertion cavity 118 on one side of block 102, more stability is provided for an inserted wire and punch down tool.

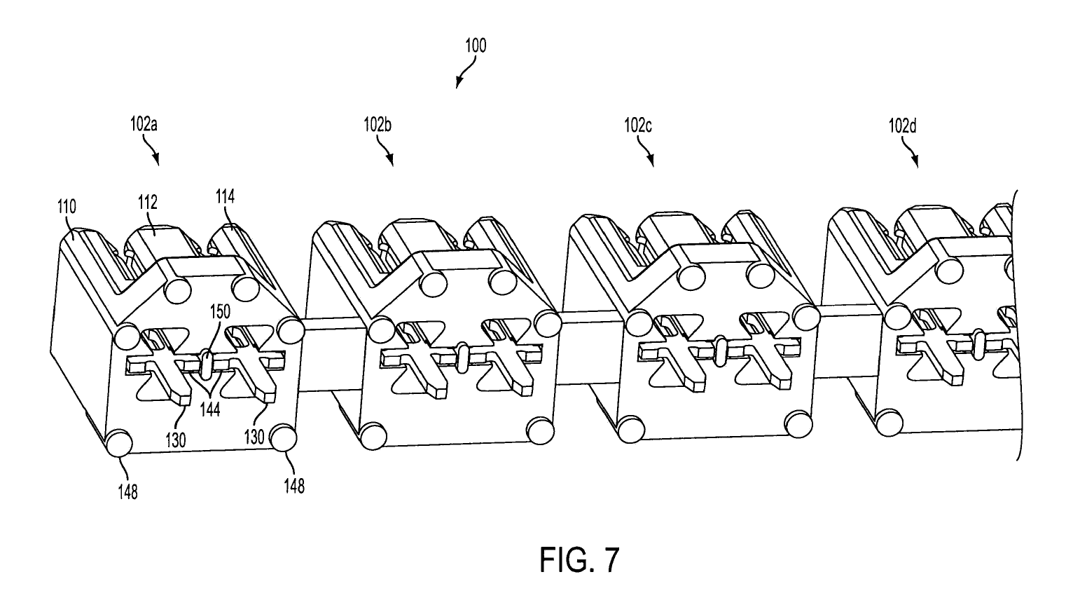

With continuing reference to FIG. 6, insulation displacement contacts 130 are installed in block 102a so that a short edge 144 of each insulation displacement contact 130 faces, and is in the same plane as, an edge 144 of an adjacent contact 130. The inventors have discovered that, as edges 144 of contacts 130 are shorter than sides 146, disposing edges 144 so that they face one another, significantly reduces crosstalk of data communicating within each block and between adjacent blocks. FIG. 7 shows a bottom view of strip 100 and further illustrates the facing of edges 144 of contacts 130. FIG. 7 also shows support pads 148 which are spread apart on a bottom of block 102 and may be used to provide stability for block 102a.

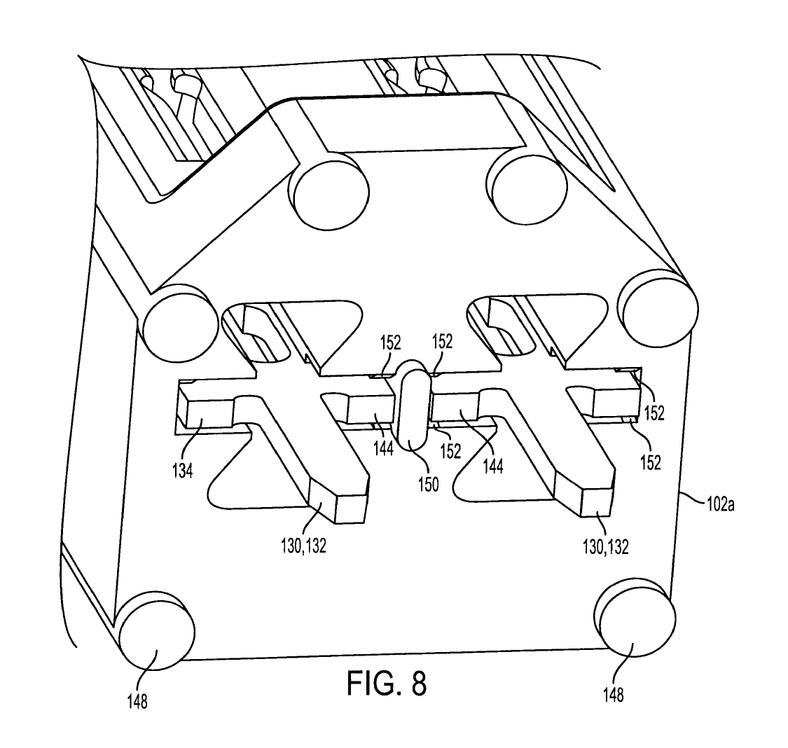

FIG. 8 shows a bottom view of contact block 102a and still further illustrates the placement of contacts 130 and edges 144. Also shown is a stand-off isolation element 150 which may be used to further reduce communication between terminals 130 within a single block 102a. Ramps 152 may be used to facilitate support and placement of terminals 130 within block 102.

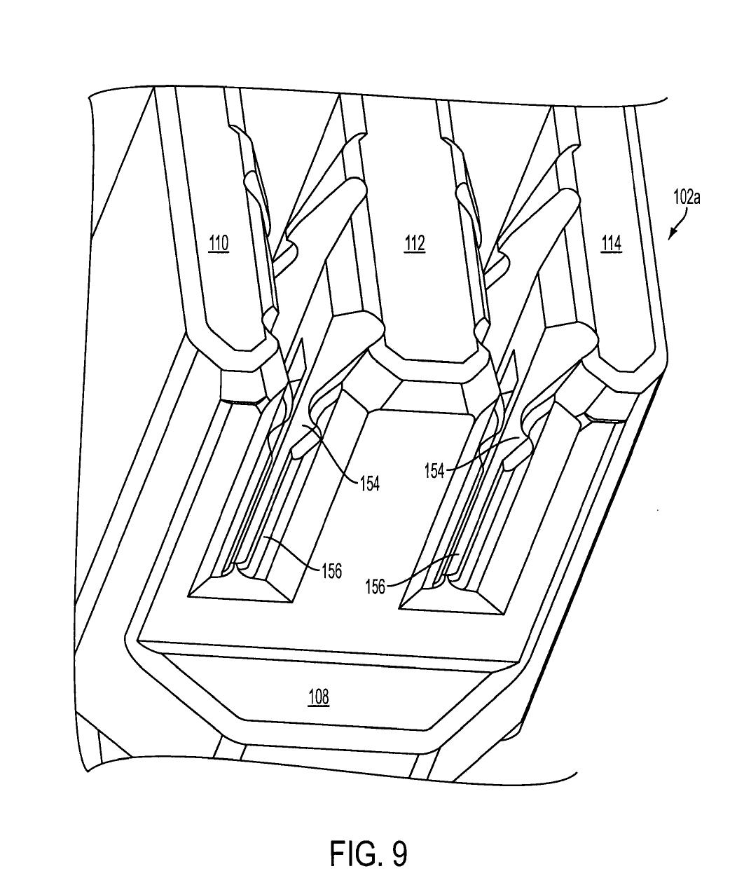

FIG. 9 shows wire notches 154 which may be used to retain a wire inserted into block 102a before the wire is punched down by a punch down tool. After the wire is punched down, wire support flanges 156 may be used to maintain and inhibit movement of the wire.

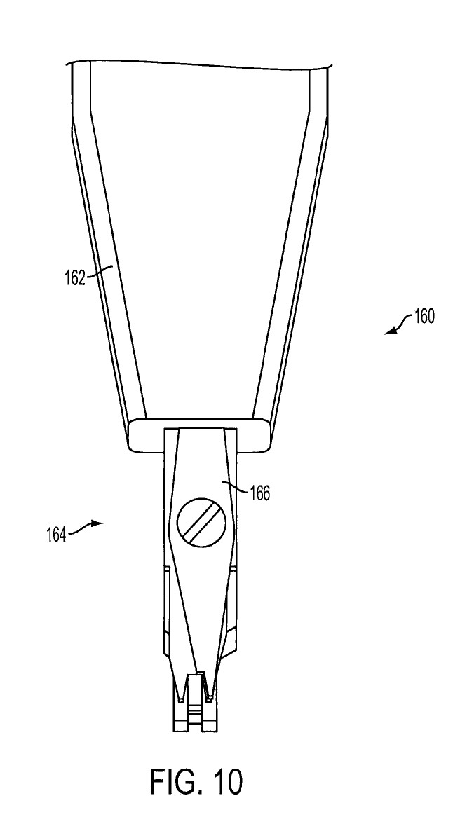

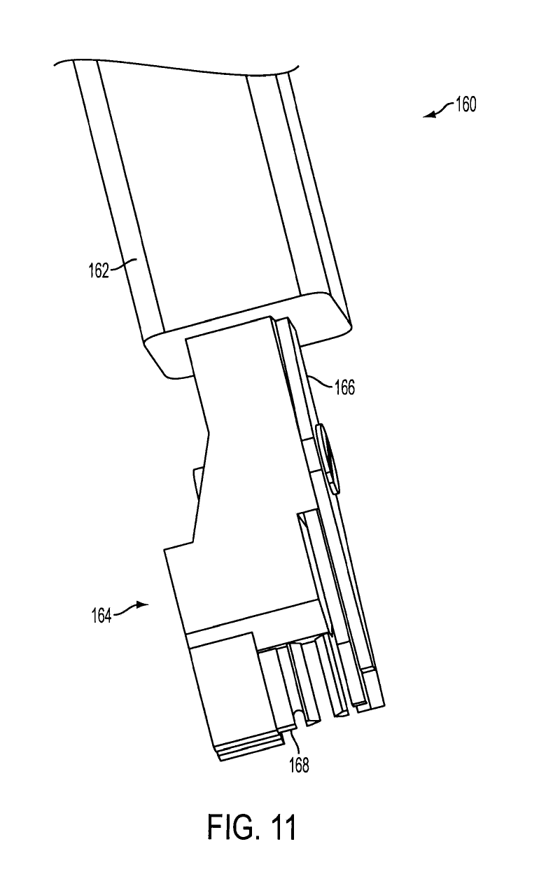

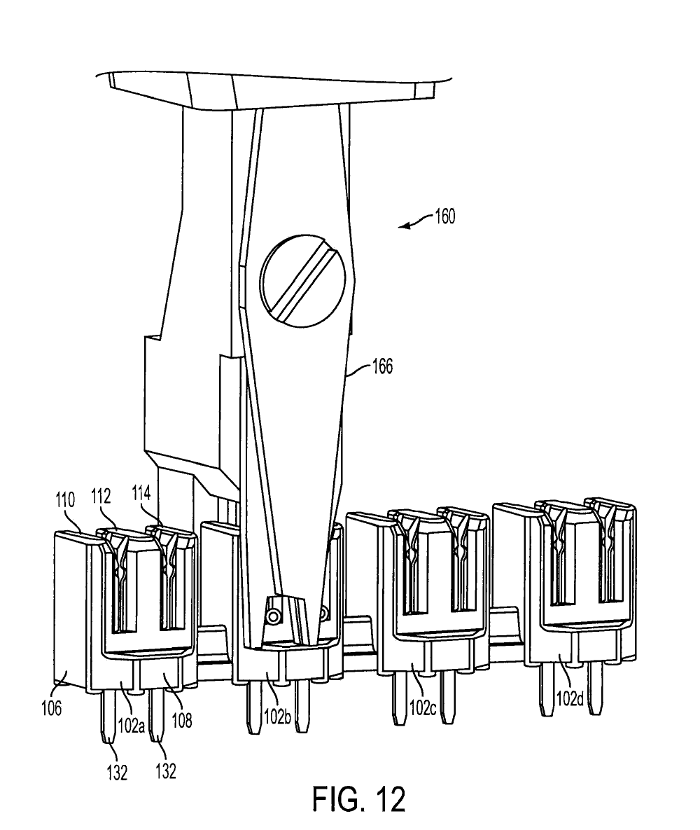

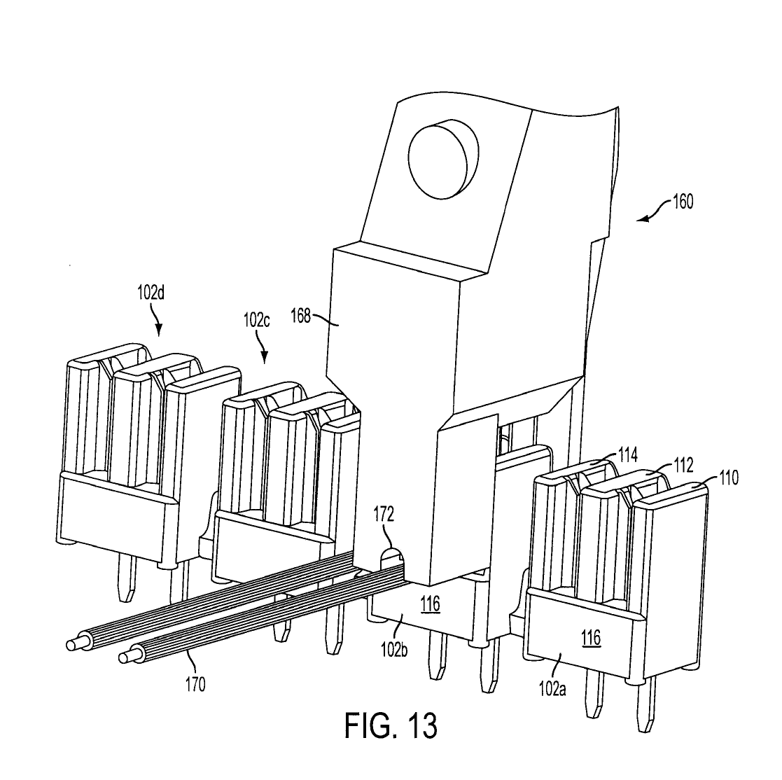

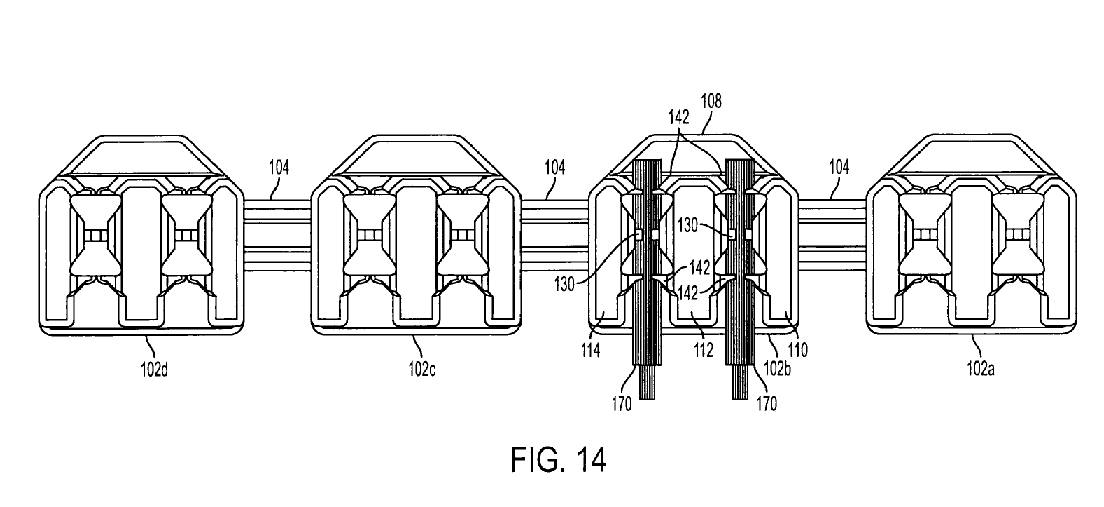

An example of a punch down tool 160 is shown in FIGS. 10 and 11. Punch down tool 160 includes a handle 162 and a punch down portion 164. Punch down portion 164 includes a wire trim side 166 and a wire push side 168. Wire push side 168 has a cross-sectional area matching punch down tool clearance cavities 122 (FIG. 6) so that punch down tool 160 may be received by block 102. FIGS. 12 and 13 show punch down tool 160 being used to punch and trim a wire 170 inserted into block 102b. A recess 172 (FIG. 13) may be cut out of wire push side 168 so as to allow room for wire 170. As base 106 of block 102 includes a flat portion 116, additional support is provided for punch down tool 160 when used. FIG. 14 shows wire 170 punched down into block 102b. Insulation displacement contacts 130 are disposed edge to edge and are shown piercing and retaining wire 170. Furthermore, wire retention flanges 142 retain wire 170 within block 102b.

Thus, the following steps may be followed to insert a wire into an insulation displacement contact block in accordance with an embodiment of the invention. An assembler may place wire 170 into wire insertion cavity 118 (FIG. 6) on a wire insertion side of contact block 102. The assembler will continue inserting wire 170 so that it rests on wire notches 154 (FIG. 9). Thereafter, punch down tool 160 (FIG. 12) is used to punch down the wire into the contact block. Sharp edges 140 of tines 136 (FIG. 5) pierce the insulation of the wire and wire retention flanges 142 (FIG. 14) retain the wire within block 102.

Referring again to FIG. 2, each block 102 includes a first wire insertion opening 174 and a second wire insertion opening 176 defined by walls 110, 112 and 114. A center of first and second opening 174, 176 within each block may be spaced apart from one another by a distance of, for example, between 0.080 and 0.200 inches. A tie bar 104 may be used to orient and place a plurality of blocks 102, for example four bocks, relative to one another. Tie bar 104 is designed to facilitate insertion and handling of blocks 102 into a circuit board. For example, a length of tie bar 104 may be designed so that a distance from a center of first opening 174 in a first block (e.g. block 102b) to a center of first opening 174 in a second block (e.g. 102c) is 0.390 inches. A height of each block 102 may be designed so as to allow for an automatic triggering of punch down tool 160 when tool 160 is used.

Tie bar 104 allows an assembler or assembly machine to easily place a plurality of blocks onto a circuit board while maintaining relative positions of the blocks. Alternatively, each block may be easily broken off from the tie bar and used individually or in smaller groups. For example, a single block may be used as a ground or power outlet. Two blocks may be used for a wall or phone outlet, etc. Such flexibility in insulation displacement contact blocks is generally not available in the prior art.

FIG. 15 shows 4 strips 100 (100a, 100b, 100c, 100d), each including four contact blocks 102 disposed on a circuit board 178. Circuit board 178 allows for electrical communication, such as through electrical traces, between blocks 102 and jacks 186. Each block 102 may have an associated shield 180 disposed external to the block. Shield 180 has three sides so as to shield each block from internal cross talk from neighboring blocks in the same channel or strip and from crosstalk from adjacent channels (e.g. adjacent strips 100a, 100b)—sometimes referred to as alien or exogenous crosstalk. An opening on one side of shield 180 allows an assembler to insert a wire into a block 102. Shield 180 is inserted into circuit board 178 through the use of a projection and opening 182. In this way, all shields 180 are placed at a common voltage potential.

Blocks 102 alone can communicate at speeds of 500 MHz without significant undesired crosstalk. Prior art devices could not handle such speeds without a shield. These shields increase the cost of such devices. With shield 180, blocks can communicate at speeds of 1000 MHz without significant undesired crosstalk—a speed not available with prior art insulation displacement contact devices. Some prior art devices include a shield within the insulation displacement contact block itself. Such placement of the shield means that more holes are required in the circuit board yielding a more expensive board. Moreover, the prior art is completely devoid of shielding between communication channels—e.g. between strip 100a and strip 100b. Clamps 184 may be used to retain wires to board 178 and minimize movement of the wire relative to blocks 102. Strips 100 may be disposed staggered from one another as shown so as to further minimize crosstalk.

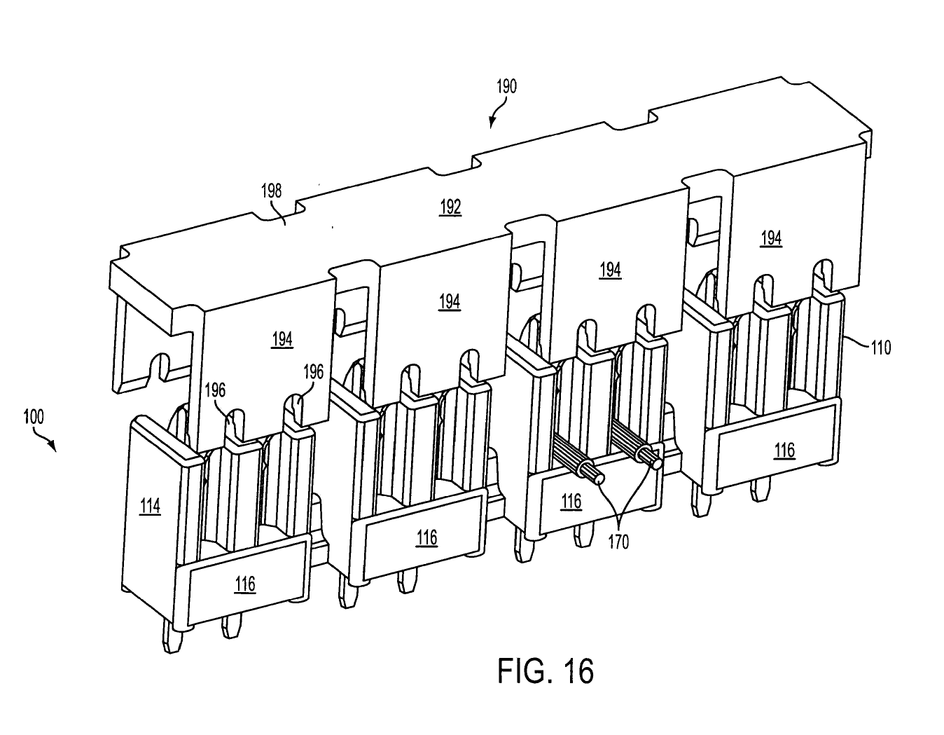

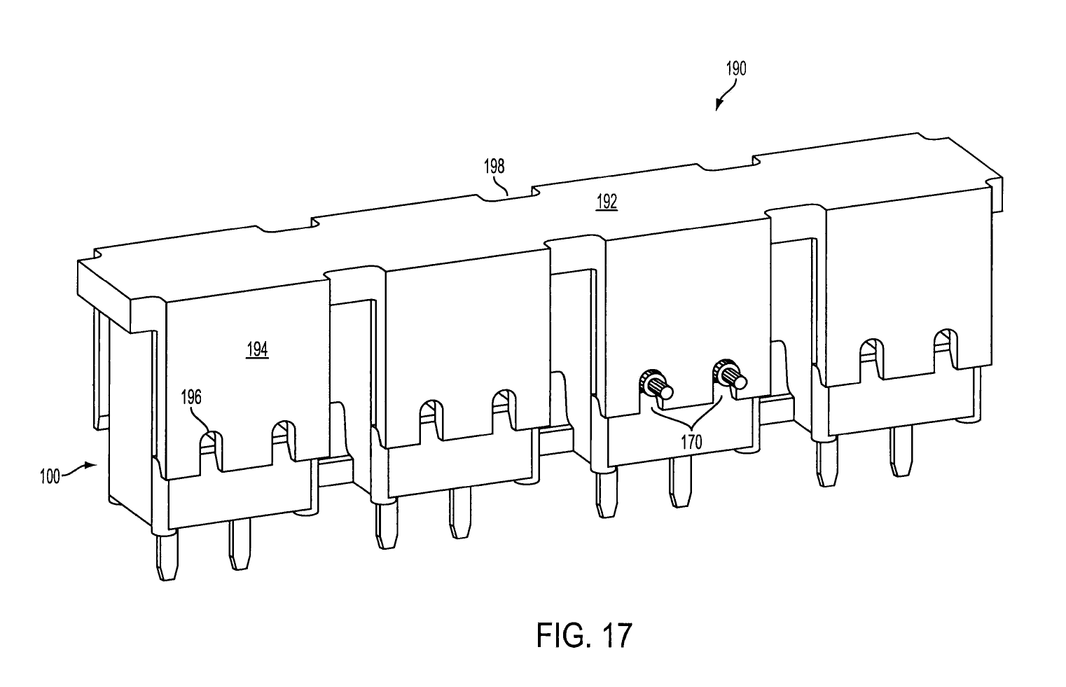

FIG. 16 shows a cover 190 which may be used in accordance with an embodiment of the invention. Cover 190 includes a base portion 192 and downwardly extending tabs 194. In the figure, four tabs 194 are shown on each of the wire insertion side and wire termination side of strip 100. Tabs 194 includes slots 196 effective to receive wires 170. As show most clearly in FIG. 17, cover 190 may be fit over strip 100 such as by, for example, snap fitting. When disposed over strip 100, cover 190 may be used to prevent accidental removal of terminated wires and may provide additional security for wire connections. Slots 198 disposed in base portion 192 allow space for walls 110, 114 of block 102. Slots 198 also enable cover 190 to be broken apart and used for an individual block 102.

Having described the preferred embodiments of the invention, it should be noted that the scope of the invention is limited only by the scope of the claims attached hereto and obvious modifications may be made without departing from the scope and spirit of the invention.

What is claimed is:

1. An insulation displacement contact block comprising:
a base;
a first, second, and third wall extending upward from the base, the first and second wall defining a first wire insertion opening, the second and third wall defining a second wire insertion opening;
a first insulation displacement contact disposed between the first and second wall, the first insulation displacement contact including a first side and a first edge, the first side being longer than the first edge;
a second insulation displacement contact disposed between the second and third wall, the second insulation displacement contact including a second side and a second edge, the second side being longer than the second edge;
wherein the first and second insulation displacement contacts are disposed so that the first edge faces, and is in the same plane as, the second edge.

2. The insulation displacement contact block as recited in claim 1, wherein the base includes a flat side.

3. The insulation displacement contact block as recited in claim 2, wherein the base includes a side with a plurality of bent portions.

4. The insulation displacement contact block as recited in claim 1, wherein the first and second wire insertion openings are disposed substantially 0.080 to 0.200 inches apart.

5. The insulation displacement contact block as recited in claim 1, wherein the first and second walls further define a wire insertion cavity and a punch tool clearance cavity.

6. The insulation displacement contact block as recited in claim 1, wherein the first and second walls further include wire retention flanges effective to retain a wire.

7. The insulation displacement contact block as recited in claim 1, wherein the base further includes a plurality of support pads disposed on a bottom thereof.

8. The insulation displacement contact block as recited in claim 1, wherein the base further includes an isolation element disposed between the first and second insulation displacement contacts.

9. The insulation displacement contact block as recited in claim 1, wherein the first and second walls further include ramps effective to guide the first and second insulation displacement contacts.

10. The insulation displacement contact block as recited in claim 1, wherein the first and second walls further include wire notches effective to hold a wire before the wire is inserted into the first insulation displacement contact.

11. The insulation displacement contact block as recited in claim 1, further comprising a shield disposed around and external to the first and third walls.

12. The insulation displacement contact block as recited in claim 11, wherein the shield includes three sides.

13. A strip of at least a first and second separable insulation displacement contact blocks, the strip comprising:
a first contact block including
a first base,
a first, second, and third wall extending upward from the first base, the first and second wall defining a first wire insertion opening, the second and third wall defining a second wire insertion opening,
a first insulation displacement contact disposed between the first and second wall, the first insulation displacement contact including a first side and a first edge, the first side being longer than the first edge, and
a second insulation displacement contact disposed between the second and third wall, the second insulation displacement contact including a second side and a second edge, the second side being longer than the second edge,
wherein the first and second insulation displacement contacts are disposed so that the first edge faces the second edge; and
a second contact block including
a second base,
a fourth, fifth, and sixth wall, each distinct from the first, second and third walls, the fourth, fifth and sixth walls extending upward from the second base, the fourth and fifth wall defining a third wire insertion opening, the fifth and sixth wall defining a fourth wire insertion opening,
a third insulation displacement contact disposed between the fourth and fifth wall, the third insulation displacement contact including a third side and a third edge, the third side being longer than the third edge, and
a fourth insulation displacement contact disposed between the fifth and sixth wall, the fourth insulation displacement contact including a fourth side and a fourth edge, the fourth side being longer than the fourth edge,
wherein the third and fourth insulation displacement contacts are disposed so that the third edge faces the fourth edge.

14. The strip as recited in claim 13, wherein the first, second, third and fourth edges are in the same plane.

15. The strip as recited in claim 13, further comprising a tie bar detachably connected between the first and second contact block.

16. The strip as recited in claim 15, wherein the first wire insertion opening is disposed substantially 0.390 inches from the third wire insertion opening.

17. The strip as recited in claim 13, further comprising a cover effective to cover the contact blocks, the cover including a base and a plurality of tabs extending from the base.

18. An arrangement comprising:
a first and second strip of insulation displacement contact blocks, each strip including at least two insulation displacement contact blocks, each insulation displacement contact block comprising:
a base,
a first, second, and third wall extending upward from the base, the first and second wall defining a first wire insertion opening, the second and third wall defining a second wire insertion opening,
a first insulation displacement contact disposed between the first and second wall, the first insulation displacement contact including a first side and a first edge, the first side being longer than the first edge, and
a second insulation displacement contact disposed between the second and third wall, the second insulation displacement contact including a second side and a second edge, the second side being longer than the second edge,
wherein the first and second insulation displacement contacts are disposed so that the first edge faces, and is in the same plane as, the second edge.

19. The arrangement as recited in claim 18, wherein the first and second strips are staggered from one another.

20. The arrangement as recited in claim 18, further comprising a plurality of shields, each shield including three sides and being disposed external to a respective insulation displacement contact block so that a side of a shield is disposed between any two insulation displacement contact blocks.
